(19) United States
(12) Patent Application Publication
(10) Pub. No.: US 2021/0319771 A1
(43) Pub. Date: Oct. 14, 2021

(54) Counter Tensioning System for Stringed Musical Instrument

(71) Applicant: Thomas Lanni, Laguna Niguel, CA (US)

(72) Inventor: Thomas Lanni, Laguna Niguel, CA (US)

(21) Appl. No.: 14/941,928

(22) Filed: Nov. 16, 2015

Related U.S. Application Data
(63) Continuation-in-part of application No. 14/556,423, filed on Dec. 1, 2014, now abandoned.

(51) Int. Cl. G10D 3/12; G10D 3/06; G10D 3/04; G10D 1/08

(52) U.S. Cl. CPC G10D 3/12; G10D 3/06; G10D 3/14; G10D 1/08; G10D 3/04

(57) ABSTRACT

A stringed musical instrument having a counter tensioning system to counteract the string tension. The counter tensioning system creates a force in opposition to the string tension preventing bowing of the neck. The counter tensioning system reduces the need for periodic adjustments and calibration. The counter tension system also allows for precise calibration of the neck bow to accommodate user preferences.

### RELATED APPLICATIONS

This application is a continuation in part of application Ser. No. 14/556,423 filed on Dec. 1, 2014 now pending.

### BACKGROUND OF THE INVENTION

The present invention relates to stringed musical instruments in general and to guitars more specifically. It has been long recognized that stringed instruments such as guitars which have a long narrow neck are prone to bowing of the neck due to the tension of the strings exerting asymmetrical compressive forces on the neck structure. The conventional solution to this problem has been the inclusion of a truss rod in the neck structure in order to counteract the compressive forces of the strings. Truss rods began being used as early as 1921 as illustrated in U.S. Pat. No. 1,446,758 to McHugh. There have been variations of this type of truss rod assembly with most all of these requiring manual adjustment to achieve the desired flatness of the neck under the forces exerted by the strings. This system has some drawbacks such as periodic recalibration required due to stress relaxation of the truss system as well as changes in string tension over time. If the user changes the type of string used on the instrument recalibration would also be required.

### SUMMARY OF THE INVENTION

It is the objective of the present invention to provide a counter tensioning system that uses the tension of the strings to provide the required counter tension normally provided by the conventional truss rod system. The system of the present invention reduces the need for periodic re-calibration. The system of the present invention also allows for precise calibration of the neck bow to accommodate user preferences.

### DESCRIPTION OF THE DRAWINGS

FIG. 1A depicts the neck assembly of an embodiment of the invention;

FIG. 1B depicts a cross section of the neck assembly taken along the line A-A of FIG. 1A showing the details of the counter tensioning system;

FIG. 2 is a detail view of the bell crank assembly of the counter tensioning system;

FIG. 3 is a detail view of the lever assembly of the counter tensioning system; And

FIG. 4 is a detailed view of the force balance adjustment system.

### DETAIL DESCRIPTION OF THE INVENTION

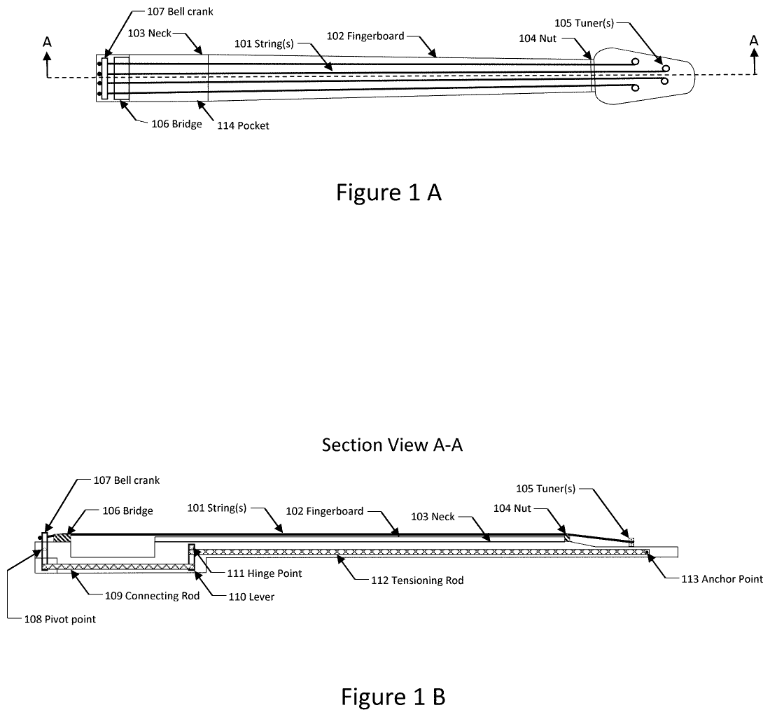

A top view of the preferred embodiment of the invention is depicted in FIG. 1A. In this embodiment a neck assembly for a four string bass guitar is shown. A bass guitar has substantial string forces due to its lower pitch and larger string diameters. The basic neck structure 103 may be formed from a solid wood blank such as maple or other reasonably stable wood species. Other materials may also be used such as metals or carbon fiber. The neck structure 103 may have a pocket 114 between the bridge and the fingerboard to accommodate one or more electronic pickups.

Attached to the neck structure 103 is the fingerboard 102. The fingerboard 102 may be made from wood or other suitable materials. The fingerboard 103 may have frets (not shown) attached to it as with any conventional guitar fingerboard. The fret is normally made of wire having a tang protruding along the length of the wire. The frets may be installed in slots cut into the fingerboard and may be pressed and/or glued into place. Decorative inlays of pearl or plastic may be inset into the fingerboard to act as markers for the player of the instrument to indicate the note of a particular fret.

The string(s) 101 may be suspended between the bridge 106 and the nut 104. The bridge 106 may have devices for each string to allow for adjustment of the height of the string relative to the fingerboard 102 as well as adjustment of the contact point of the string on the bridge. The height adjustment allows the gap between the fingerboard 102 or frets mounted thereon and the strings 101 to be set to a desired level to achieve maximum playability. This is generally referred to as the “action” of the neck. The contact point adjustment allows for the setting of the distance between the contact points of the string(s) 101 on the bridge 106 relative to the contact point on the nut 104. This allows for the calibration of the intonation of the instrument. One or more of the strings 101 may be connected to the bell crank 107 on the one end and to the tuner(s) 105 on the other end. The nut 104 may be made from any suitable material that protrudes above the fingerboard 102 such that when the string(s) 101 rest upon the nut there is clearance between the string(s) 101 and the fingerboard 102. The nut may also be formed by a fret installed into the fingerboard 102 as previously discussed.

FIG. 1B shows a cross section view of the neck assembly taken along the line A-A of FIG. 1A. The bell crank 107 may be anchored to the neck structure 103 at a pivot point 108 such that the bell crank is allowed to rotate about the pivot point 108 in a direction parallel to the length of the neck structure 103. One end of the bell crank 107 may be connected to one or more strings as previously described. The opposite end is connected to one end of the connecting rod 109 such that the pivot point 108 is between the two connection points. The other end of the connecting rod 109 is connected to one end the lever 110. The opposite end of the lever 110 may be attached to the neck structure at the hinge point 111. The attachment at the hinge point 111 is such that the lever 110 is allowed to rotate about the hinge point 111 in a direction parallel to the length of the neck structure 103. One end of the tensioning rod 112 may be connected to the lever 110 at an intermediate point between the hinge point 111 and the connecting rod 109. The other end of the tensioning rod may be anchored by anchor point 113 to the neck structure at a location in the vicinity of the nut 104 and the tuner(s) 105.

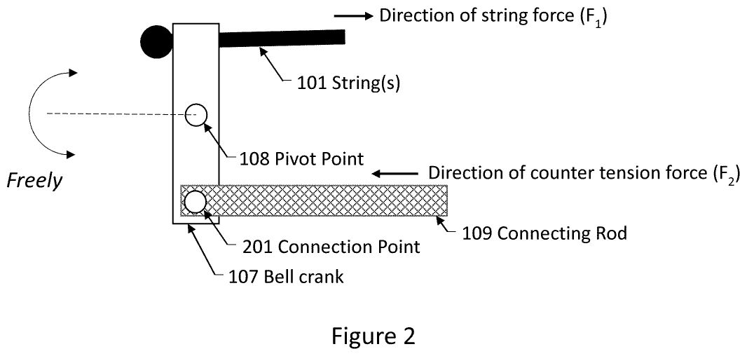

FIG. 2 shows a detailed view of the bell crank 107 operation. As previously described the bell crank 107 freely rotates about the pivot point 108. The pivoting action of the bell crank redirects the string force F₁ creating a counter tension force F₂. The counter tension force F₂ is proportional to the string force F₁ by the ratio of the distance from each of the connecting points to the pivot point 108. The relationship can be determined by the following equation:

F₂=(D₁/D₂)F₁

### Where:

D₁ is the distance from the connection point of the string(s) 101 to the pivot point 108.
D₂ is the distance from the connection point 201 to the pivot point 108.

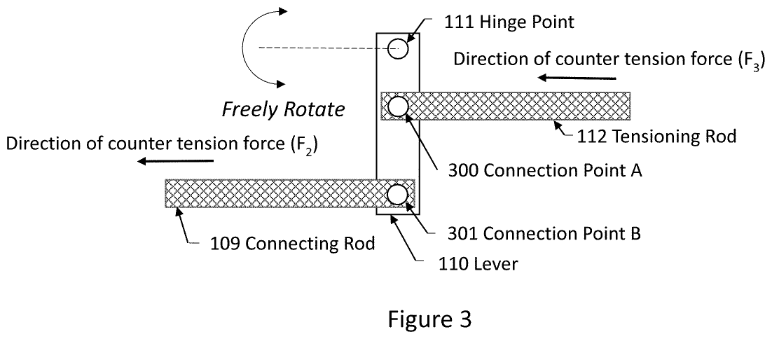

FIG. 3 shows a detailed view of the lever 110 operation. As previously described the lever 110 freely rotates about the hinge point 111. The connecting rod 109 connects to the lever 110 at connection point B 301. The opposite end of the connecting rod 109 connects to the connection point 201 shown in FIG. 2. The tensioning rod 112 connects to the lever at connection point A 300. The opposite end of the tensioning rod 112 connects to the anchor point 113 shown in FIG. 1B. The lever may be used to amplify the counter tension force F₂ creating a greater counter tension force F₃. The counter tension force F₃ is directly proportional to the counter tension force F₂ by the ratio of the respective distances between each of the connecting points (300 and 301) and the hinge point 111. The relationship can be determined by the following equation:

F₃=(D₃/D₄)F₂

### Where:

D₃ is the distance from the connection point B 301 to the hinge point 111.
D₄ is the distance from the connection point A 300 to the hinge point 111.

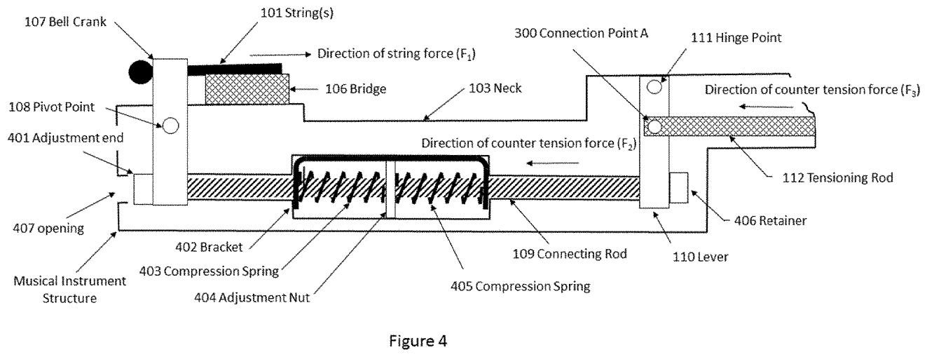

FIG. 4 shows a detailed view of a force balance adjustment system which allows the user to calibrate the amount of bow in the neck to accommodate the players preference and playing style. In this embodiment the connecting rod 109 may be a threaded rod which may pass through a hole in the lever 110 and may be captured by retainer 406. The connecting rod 109 may rotate freely in the lever 110 such that it may be rotated about its axis. The opposite end of the rod may pass through a hole or opening on the bell crank 107 and may rotate freely about its axis with respect to the bell crank 107. The adjustment end 401 may be fixed to the connecting rod 109 and may have a socket or the like to accept a tool such as an Allen wrench to facilitate the rotating of the connecting rod 109 to adjust the force applied to the tensioning rod 110. The force adjustment may be accomplished by the use of a pair of opposing compression springs 403 and 405 which may be affixed to the neck structure 103 by way of bracket 402. As the connecting rod 109 is rotated in one direction the adjustment nut 404 moves toward the compression spring 405 thus compressing the spring and adding additional force in the direction of the counter tension force F₂ which increases the counter tension force F₃. When the connecting rod 109 is rotated in the opposite direction the adjustment nut 404 moves in the direction of the compression spring 403 thus compressing the spring and adding a force in opposition to the counter tension force F₂ which reduces the counter tension force F₃. The tensioning rod 112 may be enclosed in the neck structure such that it is not externally visible. The adjustment end 401 may be positioned in front of an opening 407 in the musical instrument structure such that the adjustment end is accessible to the user by inserting a tool through the opening 407.

The preferred embodiment presented is one of many possible variations and is not intended to limit the spirit of the invention. It is intended that the claims embrace all such possible variations that would still embrace the spirit of the invention.

What is claimed is:

1. A stringed musical instrument comprising:
a neck structure having a length and width and thickness forming a long narrow beam having proximal and distal ends with a fingerboard partially along its length;
one or more strings stretched along the length of the neck structure;
a bridge upon which the strings rest at the proximal end of the neck structure;
a nut upon which the strings rest at the distal end of the neck structure;
and a mechanical device located on the proximal end of the neck structure which redirects the tension force of the strings to create a counter tension force in opposition to the string tension force where said counter tension force is applied by way of a tensioning rod anchored directly to the distal end of the neck structure, said counter tension force being at a fixed ratio of the string tension force.

2. The counter tensioning system of claim 1 where said tensioning rod is enclosed in the neck structure.

3. The counter tensioning system of claim 1 including a force balance adjustment system having at least one compression spring which when compressed by the adjustment system exerts a force to either add or subtract from the counter tension force.

4. The force balance system of claim 3 including a threaded connecting rod which when rotated about its axis acts to compress said compression spring.

5. The force balance system of claim 4 where the said connecting rod includes an adjustment end which is accessible to the user through an opening in the musical instrument structure.
